(19) United States
(12) Patent Application Publication
(10) Pub. No.: US 2024/0149858 A1
(43) Pub. Date: May 9, 2024

(54) SYSTEM, METHOD AND DEVICE FOR IMPLEMENTING A DUAL AIR SUPPLY FOR BRAKING SYSTEMS

(71) Applicant: Bendix Commercial Vehicle Systems LLC, Avon, OH (US)

(72) Inventors: Ran Wei, North Ridgeville, OH (US); Tandi Wijaya, Highland Heights, OH (US); Thomas J. Hayes, Lakewood, OH (US); Michael D. Cremona, Lakewood, OH (US)

(21) Appl. No.: 18/052,959

(22) Filed: Nov. 7, 2022

(51) Int. Cl. B60T 17/08; B60T 13/38

(52) U.S. Cl. CPC B60T 17/083; B60T 13/38

(57) ABSTRACT

A braking system for an air brake vehicle includes a source of working pressure and a source of vacuum pressure. The system includes at least one brake actuator having a first chamber for receiving the working pressure, a second chamber for receiving the vacuum pressure; and a push rod that moves linearly in response to pressure in the first chamber and second chamber. A brake assembly is mechanically connected to the push rod for applying friction to a wheel end of a vehicle in response to the linear movement of the push rod.

### BACKGROUND

The present application relates to a system, method and device to provide enhanced braking through the use of a dual air supply.

In commercial vehicle applications, air brakes are used to stop the vehicle. A brake actuator is placed at each wheel end for receiving working air, in response to a signal indicating that the driver wants the service brakes applied. The brake actuator is separated into two chambers by a diaphragm. Working air enters the first chamber of the brake actuator through an inlet port. The working air acts upon a diaphragm and against atmospheric pressure in the second chamber on the opposite side of the diaphragm. The movement of the diaphragm moves a push rod assembly. The push rod assembly moves an S-cam to actuate a drum brake. In a disc brake, the push rod moves an actuator device. The working air works against atmospheric pressure that is consistently present in the second chamber. The greater the air pressure admitted to the first chamber of the brake actuator, the greater the force applied to the brake assembly. When the air pressure is released from the first chamber, a push rod return spring returns the diaphragm to its released position.

There is interest in improving the structure and operation of the brake actuator and braking system, which will assist commercial vehicles in achieving shorter stopping distances.

### SUMMARY

In accordance with one embodiment, a brake actuator includes a housing having two chambers, an inlet at the first chamber for a receiving a working pressure, an inlet at the second chamber for receiving a vacuum pressure and a diaphragm separating the first chamber from the second chamber. A push rod moves to a brake actuated position in response to the working pressure being greater than vacuum pressure.

In accordance with another embodiment, a braking system for an air brake vehicle includes a source of working pressure and a source of vacuum pressure. The system includes at least one brake actuator having a first chamber for receiving the working pressure, a second chamber for receiving the vacuum pressure and a push rod that moves linearly in response to pressure in the first chamber and second chamber. A brake assembly is mechanically connected to the push rod for applying friction to a wheel end of a vehicle in response to the linear movement of the push rod.

In accordance with another embodiment, a method for controlling an actuator of an air brake system includes providing compressed air to a brake controller, transmitting a service brake request signal to a brake controller and a vacuum controller, providing working pressure to a first chamber of a brake actuator in response to the service brake request signal and providing vacuum pressure to a second chamber of the brake actuator in response to the service brake request signal. The method results in moving a push rod to actuate a brake assembly connected to the brake actuator in response to the working pressure.

### BRIEF DESCRIPTION OF THE DRAWINGS

FIG. 1 is a representation of a brake system having the brake actuator according to the invention.

FIG. 2 is a close up view of the brake actuator according to the invention.

FIG. 3 is a flowchart of the operation of the inventive brake system.

### DETAILED DESCRIPTION

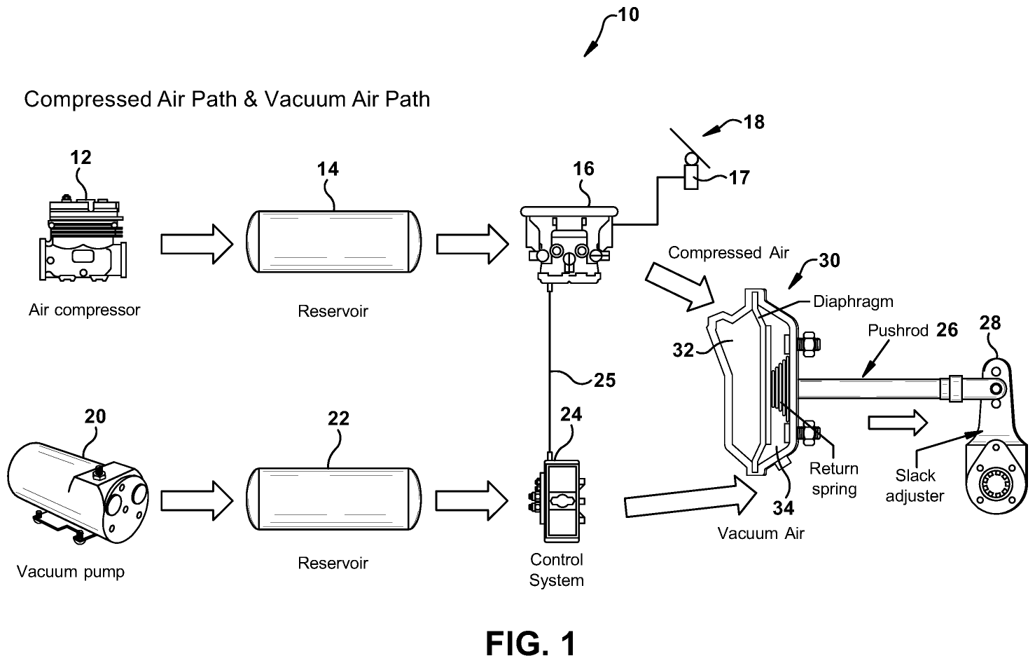

Referring to FIG. 1, a brake system 10 having an improved air brake actuator 30 is depicted.

An air compressor 12 provides the source of compressed air for the braking system. As air is compressed, it is stored in a first reservoir 14.

When the driver wants to apply the service brakes of the vehicle, she actuates foot brake valve 18. Foot brake valve 18 communicates with a brake controller 16 pneumatically using the pressure from the first reservoir 14 and/or electrically via a pressure sensor 17. Brake controller 16 includes control logic, pneumatic valves, and electro-pneumatic valves to act upon the driver's indication that she wants service brakes applied.

In response to the driver's desire for service brake application, brake controller 16 provides the working air to a first side 32 of at least one brake actuator 30, which is configured to receive the relatively high pressure air. A typical commercial vehicle, such as a tractor, has brake actuators at each wheel end. Therefore, the brake controller 16 will communicate with at least four brake actuators and up to fourteen brake actuators on a multi-axle heavy duty vehicle. Brake controller 16 will also communicate electrically with a vacuum controller 24 via a communications bus 25.

At the same time, vacuum pump 20 provides vacuum pressure air to a second reservoir 22. When the vacuum controller 24 receives the signal indicating that the driver wants to brake the vehicle, the vacuum controller 24 opens a path for the vacuum to be created in a second side 34 of the at least one brake actuator 30. In this manner, the first side 32 has less force to overcome to move the pushrod 26 in order to actuate the brake assembly. This feature results in faster apply times for the at least one brake actuator 30. In the version with the slack adjuster 28, a drum brake is actuated. This system 10 may also be used to actuate a disc brake.

When the driver removes her foot from the foot brake valve 18, the working pressure is released from the first side 32 of the at least one brake actuator 30 by the brake controller 16 and exhausted to atmosphere. The vacuum may be released from the second side 34 of the at least one brake actuator 30 as well, or the vacuum may remain in preparation for the next brake application.

In another embodiment of the system 10, a different configuration of air compressor 12 can be used to both generate the compressed air and generate the vacuum air. In one example, the compression stroke of the compressor 12 would generate the compressed air and the return stroke would generate the vacuum. The compressor 12 would be separated into different chambers to capture the different sources of air and transmit to either the first reservoir 14 or the second reservoir 22. The separate vacuum pump 20 would not be used.

In another embodiment of the system 10, the brake controller 16 and the vacuum controller 24 would be combined into a single controller that performs both functions. The single controller would include input for the brake signal from the foot brake valve 18 via the sensor 17 or via a direct pneumatic connection to the foot brake valve 18. The pneumatic portion of the single controller would have two supply ports, one for receiving the working pressure from the first reservoir 14 and one for receiving vacuum pressure from the second reservoir 22, a control port connected to the foot brake valve 18, and two delivery ports, one for delivering working pressure to the first side 32 and one for delivering vacuum air to the second side 34.

Therefore, a braking system for an air brake vehicle includes a source of working pressure and a source of vacuum pressure. The system includes at least one brake actuator having a first chamber for receiving the working pressure, a second chamber for receiving the vacuum pressure; and a push rod that moves linearly in response to pressure in the first chamber and second chamber. A brake assembly is mechanically connected to the push rod for applying friction to a wheel end of a vehicle in response to the linear movement of the push rod.

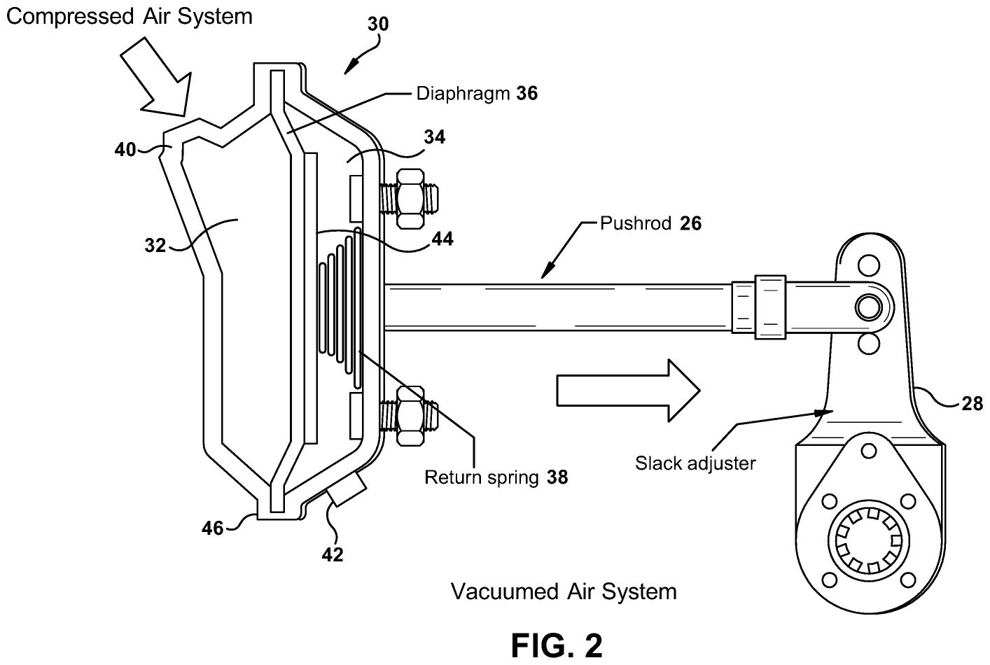

FIG. 2 shows a close up view of the brake actuator 30.

The brake actuator 30 may be a diaphragm brake actuator. The diaphragm actuator converts the energy of air pressure into mechanical force. The brake actuator 30 is split into two chambers, a first side 32 and a second side 34, by a diaphragm 36. The two chambers with the separating diaphragm 36 may be clamped together by an exterior clamping ring 46 or otherwise fastened together.

The first side 32 includes an input port 40. The input port 40 is connected to a source of compressed air, such as the working pressure from the brake controller 16.

Instead of a vent to atmosphere as in typical diaphragm actuators, an input port 42 in the second side 34 is present. The input port 42 is connected to a source of vacuum air, such as would be provided by the vacuum controller 24. A return spring 38 is provided on the second side 34 to assist in returning the brake actuator 30 to a released position when the working pressure is removed from the first side 32.

A push rod plate 44 abuts the diaphragm 36 and is connected to the pushrod 26. As the diaphragm 36 is moved in response to the working pressure and vacuum pressure differential, the pushrod plate 44 moves the push rod 26. As the push rod 26 moves linearly, the slack adjuster 28 is moved if it is attached to a drum brake assembly. If it is a disc brake assembly, the push rod 26 acts directly on the actuator of the disc brake.

The amount of force necessary to move the push rod 26 depends upon the effective area of the diaphragm 26 and the amount of working pressure applied. In this brake actuator 30, the amount of force required is lessened because the pressure in the first side 32 is acting on a vacuum instead of atmospheric pressure. The presence of vacuum pressure in the second side 34 assists the diaphragm 36 in movement toward the second side 34. The second side 34 may be returned to atmospheric pressure through a vent in the vacuum controller 24 in order to assist in the return of the brake actuator to the released position. The return spring 38 also assists in the return of the push rod to the released position.

Due to the reduction in force necessary to move the push rod 26, the overall size of the brake actuator 30 may be reduced when using the vacuum. Additionally, the operating pressure of the compressed air portion of the system may be reduced by the value of atmospheric pressure. For example, 150 psi may be the normal operating pressure for a system without the vacuum. With the vacuum as in brake system 10, the upper limit pressure at which the compressor operates can be reduced to about 135 psi.

Therefore, a brake actuator includes a housing having two chambers, an inlet at the first chamber for a receiving a working pressure, an inlet at the second chamber for receiving a vacuum pressure and a diaphragm separating the first chamber from the second chamber. A push rod moves to a brake actuated position in response to the working pressure being greater than vacuum pressure.

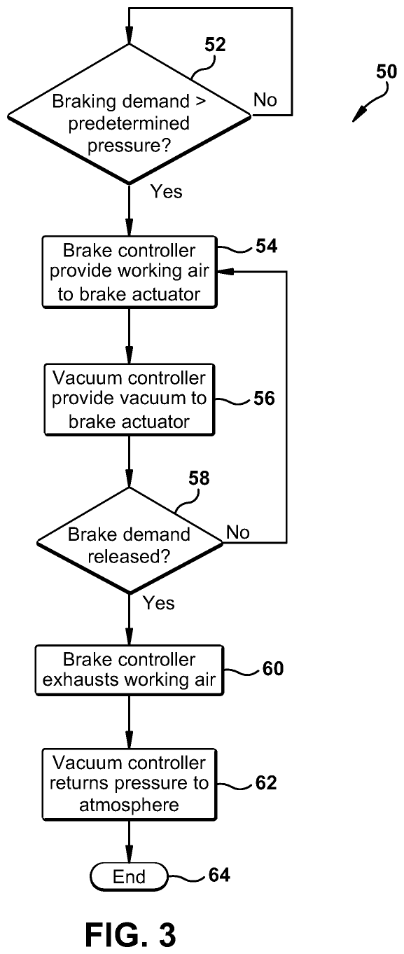

FIG. 3 shows a method 50 of controlling the brake actuator. In step 52, the brake controller 16 monitors for the driver's request for service brakes to be applied by looking for a working pressure signal or electrical signal from a pressure sensor 17 associated with the foot brake valve 18 that indicates the driver has applied the foot brake valve 18. If there is no signal, the method 50 is idle.

If a signal is received in step 52, the brake demand pressure is compared to a predetermined pressure. If the brake demand pressure is less than or equal to the predetermined pressure, the vacuum air path is inactive and only compressed air path is active. The method 50 continues to compare the brake demand to the predetermined pressure. In one example, the predetermined pressure is about fifteen (15) psi.

When the brake demand is higher than the predetermined pressure, both vacuum air and compressed air will act at the same time. The method 50 continues to step 54.

The brake controller 16 provides working air pressure to the brake actuator 30. The working air pressure may be the pneumatic signal as received from the foot brake valve 18 or may be representative of the pressure value of the foot brake valve 18. In addition, the brake controller 16 may automatically provide a working pressure if certain functions are active, such as stability control or collision mitigation. In another example, a service brake actuation may be requested by an autonomous driving system communicating with or integrated into the brake controller 16.

In step 56, the brake controller 16 sends a signal that the working pressure has been applied to the vacuum controller 24. The vacuum controller 24 will in response provide the vacuum pressure from the second reservoir 22 to the brake actuator 30. In the version having a single controller, the working air and the vacuum pressure would be supplied at the same time.

The method 50 monitors for the release of the foot brake valve 18 or discontinuation of the automatic brake intervention in step 58. As long as service brakes are still requested, the method 50 returns to step 54. If the driver or the automatic brake requests release of the service brakes, the method 50 continues to step 60.

In step 60, the brake controller 16 exhausts the pressurized air from the brake actuator 30. In step 62, the vacuum controller 24 discontinues the supply of vacuum air to the brake actuator 30 and the second side 34 of the brake actuator 30 returns to atmosphere through a vent in the vacuum controller 24. In an alternative embodiment, the vacuum air remains in the brake actuator as long as the vehicle is running. In a version with a single controller, the release of the working air and the vacuum air can happen in parallel. The return spring 38 still returns the push rod to the brake released state. The method 50 ends at step 64.

Therefore, a method for controlling an actuator of an air brake system includes providing compressed air to a brake controller, transmitting a service brake request signal to a brake controller and a vacuum controller, providing working pressure to a first chamber of a brake actuator in response to the service brake request signal and providing vacuum pressure to a second chamber of the brake actuator in response to the service brake request signal. The method results in moving a push rod to actuate a brake assembly connected to the brake actuator in response to the working pressure.

In a situation where the brake system 10 may lose compressed air, due to a leak elsewhere in the braking system for example, the vacuum air may still provide some emergency braking action. The differential in air pressure between the first side 32 and the second side 34 can move the push rod 26 toward the second side 34. In a situation where the vacuum air is lost, the brake system 10 will still provide full braking action, but the actuation time will be slower than when the vacuum air was present.

While the present invention has been illustrated by the description of example processes and system components, and while the various processes and components have been described in detail, applicant does not intend to restrict or in any way limit the scope of the appended claims to such detail. Additional modifications will also readily appear to those skilled in the art. The invention in its broadest aspects is therefore not limited to the specific details, implementations, or illustrative examples shown and described. Accordingly, departures may be made from such details without departing from the spirit or scope of applicant's general inventive concept.

What is claimed is:

1. A brake actuator comprising:
a housing having two chambers;
an inlet at the first chamber for a receiving a working pressure;
an inlet at the second chamber for receiving a vacuum pressure;
a diaphragm separating the first chamber from the second chamber; and
a push rod that moves to a brake actuated position in response to the working pressure being greater than vacuum pressure.

2. The brake actuator as in claim 1, further comprising a return spring in the second chamber for returning the push rod to a brake released position when the working pressure is removed from the first chamber.

3. A braking system for an air brake vehicle comprising:
a source of working pressure;
a source of vacuum pressure;
at least one brake actuator having
a first chamber for receiving the working pressure;
a second chamber for receiving the vacuum pressure; and
a push rod that moves linearly in response to pressure in the first chamber and second chamber;
a brake assembly mechanically connected to the push rod for applying friction to a wheel end of a vehicle in response to the linear movement of the push rod.

4. The braking system as in claim 3, wherein the source of working pressure is compressed air from an air compressor as transmitted in response to the movement of a brake pedal.

5. The braking system as in claim 3, wherein the source of vacuum pressure is a vacuum pump.

6. The braking system as in claim 3, further comprising a brake controller for receiving the working pressure from the brake pedal and transmitting the working pressure to the at least one brake actuator.

7. The braking system as in claim 6, wherein the brake controller further transmits a signal to a vacuum controller in response to transmitting the working pressure.

8. The braking system as in claim 7, further comprising the vacuum controller for transmitting the vacuum pressure to the at least one brake actuator in response to the signal that the working pressure is being transmitted to the brake actuator.

9. The braking system as in claim 6, wherein the brake controller further transmits the vacuum pressure to the at least one brake actuator.

10. A method for controlling an actuator of an air brake system comprising:
providing compressed air to a brake controller;
transmitting a service brake request signal to a brake controller and a vacuum controller;
providing working pressure to a first chamber of a brake actuator in response to the service brake request signal;
providing vacuum pressure to a second chamber of the brake actuator in response to the service brake request signal; and
moving a push rod to actuate a brake assembly connected to the brake actuator in response to the working pressure.

11. The method as in claim 10, wherein the push rod movement with the vacuum pressure present in the second chamber is faster than without a vacuum pressure present in the second chamber.

12. The method as in claim 10, wherein the brake controller and the vacuum controller are a single controller.

13. The method as in claim 10, wherein the service brake request signal is compared to a predetermined pressure and the vacuum pressure is only provided when the service brake request signal is greater than the predetermined pressure.

14. The method as in claim 10, wherein the predetermined pressure is about fifteen (15) psi.
